(19) United States
(12) Patent Application Publication
(10) Pub. No.: US 2024/0104128 A1
(43) Pub. Date: Mar. 28, 2024

(54) INFORMATION PROCESSING APPARATUS AND STORAGE MEDIUM

(71) Applicant: NEC Corporation, Minato-ku, Tokyo (JP)

(72) Inventor: Masafumi Oyamada, Tokyo (JP)

(73) Assignee: NEC Corporation, Minato-ku, Tokyo (JP)

(21) Appl. No.: 18/275,134

(22) PCT Filed: Feb. 3, 2021
(86) PCT No.: PCT/JP2021/003965

§ 371 Date: Jul. 31, 2023

(51) Int. Cl. G06F 16/36; G06F 40/40

(52) U.S. Cl. CPC G06F 16/36; G06F 40/40

(57) ABSTRACT

In order to make it possible to correctly merge dissimilarly expressed character strings, an information processing apparatus (1) includes: a data acquisition section (11) that acquires a data set including a plurality of character string pairs in each of which whether or not character strings therein indicate the same object is known; and a conversion pattern decision section (12) that decides, based on results of trials to convert each of the plurality of character string pairs included in the data set, a conversion pattern that heightens accuracy in determining whether or not the character string pair included in the data set indicates the same object.

### TECHNICAL FIELD

The present invention relates to an information processing apparatus and the like that carry out merging of character strings.

### BACKGROUND ART

There may be a case where a record in a certain data table and a record in another data table are expressed in different manners even though those records actually indicate the same object. For example, the Nikkei stock average is sometimes expressed as “NIKKEI HEIKIN (in four Chinese characters)” or “NIKKEI (in two Chinese characters)” in Japan and sometimes expressed as “Nikkei225” in other countries.

An operation of determining whether or not such differently expressed records indicate the same object and an operation of unifying expressions of records indicating the same object are called “merging”, and have been conventionally carried out. For example, Non-Patent Literature 1 below discloses a technique for calculating a degree of similarity of character strings and merging character strings for which the calculated degree of similarity is high. Moreover, Non-Patent Literature 2 below discloses a technique for determining, by a binary classifier, whether or not two target records indicate the same object with use of a feature quantity obtained by concatenating character string vectors of the two target records.

### CITATION LIST

### Non-patent Literature

### [Non-patent Literature 1]

Jin et. al., “Efficient record linkage in large data sets”, DASFAA 2003, Proceedings of the Eighth International Conference on Database Systems for Advanced Applications, March 2003

### [Non-patent Literature 2]

Govid et. al., “Entity Matching Meets Data Science: A Progress Report from the Magellan Project”, SIGMOD 2019, pp. 389-403, June, 2019

### SUMMARY OF INVENTION

### Technical Problem

The techniques of Non-Patent Literatures 1 and 2 are effective in a case where expressions of merging target character strings are similar to each other. However, in a case where the expressions are greatly different from each other, it is difficult to correctly merge such expressions. For example, according to the techniques of Non-Patent Literatures 1 and 2, it seems to be possible to correctly carry out matching of the terms “NIKKEI HEIKIN (in four Chinese characters)” and “NIKKEI (in two Chinese characters)” that are expressed in similar manners. However, it is difficult to carry out matching of dissimilarly expressed terms “NIKKEI (in two Chinese characters)” and “NKK” (which is an abbreviation for Nikkei).

An example object of an example aspect of the present invention is to provide an information processing apparatus and the like that make it possible to correctly merge dissimilarly expressed character strings.

### Solution to Problem

An information processing apparatus according to an example aspect of the present invention includes: a data acquisition means that acquires a data set including a plurality of character string pairs in each of which whether or not character strings therein indicate the same object is known; and a conversion pattern decision means that decides, based on results of trials to convert each of the plurality of character string pairs included in the data set, a conversion pattern that heightens accuracy in determining whether or not the character string pair included in the data set indicates the same object.

An information processing apparatus according to an example aspect of the present invention includes: a conversion means that sequentially applies a plurality of conversion rules to at least one of two character strings constituting a merging target character string pair to carry out conversion; and a determination means that determines whether or not a character string pair after the conversion indicates the same object.

An information processing apparatus according to an example aspect of the present invention includes: a conversion means that sequentially applies a plurality of conversion rules to at least one of two character strings constituting a character string pair included in training data to carry out conversion, the training data being used to generate a determination model for determining whether or not a merging target character string pair indicates the same object; and a training means that generates the determination model by machine learning in which character string pairs after the conversion are used as training data.

A conversion pattern decision method according to an example aspect of the present invention includes: acquiring, by at least one processor, a data set including a plurality of character string pairs in each of which whether or not character strings therein indicate the same object is known; and deciding, by the at least one processor based on results of trials to convert each of the plurality of character string pairs included in the data set, a conversion pattern that heightens accuracy in determining whether or not the character string pair included in the data set indicates the same object.

A merging method according to an example aspect of the present invention includes: sequentially applying, by at least one processor, a plurality of conversion rules to at least one of two character strings constituting a merging target character string pair to carry out conversion; and determining, by the at least one processor, whether or not a character string pair after the conversion indicates the same object.

A training method according to an example aspect of the present invention includes: sequentially applying, by at least one processor, a plurality of conversion rules to at least one of two character strings constituting a character string pair included in training data to carry out conversion, the training data being used to generate a determination model for determining whether or not a merging target character string pair indicates the same object; and generating, by the at least one processor, the determination model by machine learning in which character string pairs after the conversion are used as training data.

A conversion pattern decision program according to an example aspect of the present invention causes a computer to function as: a data acquisition means that acquires a data set including a plurality of character string pairs in each of which whether or not character strings therein indicate the same object is known; and a conversion pattern decision means that decides, based on results of trials to convert each of the plurality of character string pairs included in the data set, a conversion pattern that heightens accuracy in determining whether or not the character string pair included in the data set indicates the same object.

A merging program according to an example aspect of the present invention causes a computer to function as: a conversion means that sequentially applies a plurality of conversion rules to at least one of two character strings constituting a merging target character string pair to carry out conversion; and a determination means that determines whether or not a character string pair after the conversion indicates the same object.

A training program according to an example aspect of the present invention causes a computer to function as: a conversion means that sequentially applies a plurality of conversion rules to at least one of two character strings constituting a character string pair included in training data to carry out conversion, the training data being used to generate a determination model for determining whether or not a merging target character string pair indicates the same object; and a training means that generates the determination model by machine learning in which character string pairs after the conversion are used as training data.

### Advantageous Effects of Invention

According to an example aspect of the present invention, it is possible to correctly merge even dissimilarly expressed character strings.

### BRIEF DESCRIPTION OF DRAWINGS

FIG. 1 is a block diagram illustrating a configuration of an information processing apparatus according to a first example embodiment of the present invention.

FIG. 2 is a flowchart illustrating flows of a training data generation method, a merging method, and a training method, according to the first example embodiment of the present invention.

FIG. 3 is an explanatory diagram illustrating a determination system according to a second example embodiment of the present invention.

FIG. 4 is a block diagram illustrating a configuration of an information processing apparatus according to a third example embodiment of the present invention.

FIG. 5 is a flowchart illustrating a flow of a process carried out by the information processing apparatus in training.

FIG. 6 is a flowchart illustrating a flow of a process carried out by the information processing apparatus in merging.

FIG. 7 is a diagram illustrating an example of a computer which executes instructions of a program that is software realizing functions of the apparatus according to each of example embodiments of the present invention.

### EXAMPLE EMBODIMENTS

### First Example Embodiment

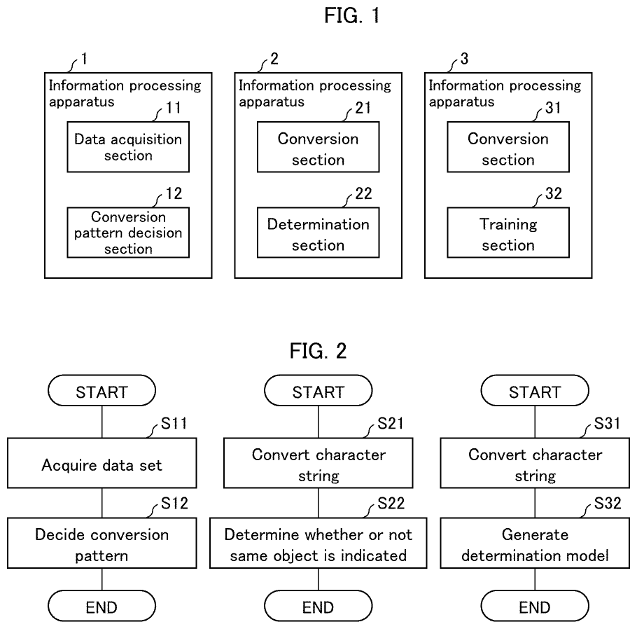

The following description will discuss a first example embodiment of the present invention in detail with reference to the drawings. The present example embodiment is a basic form of example embodiments described later. First, the following description will discuss a configuration of each of information processing apparatuses 1 through 3 according to the present example embodiment, with reference to FIG. 1. FIG. 1 is a block diagram illustrating the configuration of each of the information processing apparatuses 1 through 3.

### (Configuration of Information Processing Apparatus 1)

The information processing apparatus 1 includes a data acquisition section (data acquisition means) 11 and a conversion pattern decision section (conversion pattern decision means) 12. The data acquisition section 11 acquires a data set including a plurality of character string pairs in each of which whether or not character strings therein indicate the same object is known. The conversion pattern decision section 12 decides, based on results of trials to convert each of the plurality of character string pairs included in the data set, a conversion pattern that heightens accuracy in determining whether or not the character string pair included in the data set indicates the same object.

As described above, the information processing apparatus 1 according to the present example embodiment employs the configuration of: acquiring a data set including a plurality of character string pairs in each of which whether or not character strings therein indicate the same object is known; and deciding, based on results of trials to convert each of the plurality of character string pairs included in the data set, a conversion pattern that heightens accuracy in determining whether or not the character string pair included in the data set indicates the same object.

According to the configuration, it is possible to decide a conversion pattern that heightens accuracy in determining whether or not a character string pair indicates the same object. Here, heightening determination accuracy means that a degree of similarity of character strings increases. That is, by carrying out conversion in accordance with the conversion pattern decided by the above configuration, it is possible to make a character string pair including character strings that are dissimilarly expressed but indicate the same object be a converted character string pair constituted by character strings with higher similarity. Therefore, according to the above configuration, it is possible to bring about an example advantage of correctly merging even dissimilarly expressed character strings.

### (Conversion Pattern Decision Program)

The functions of the information processing apparatus 1 described above can also be realized by a program. A conversion pattern decision program according to the present example embodiment employs the configuration of causing a computer to function as: a data acquisition means that acquires a data set including a plurality of character string pairs in each of which whether or not character strings therein indicate the same object is known; and a conversion pattern decision means that decides, based on results of trials to convert each of the plurality of character string pairs included in the data set, a conversion pattern that heightens accuracy in determining whether or not the character string pair included in the data set indicates the same object. Therefore, according to the conversion pattern decision program of the present example embodiment, it is possible to bring about an example advantage of correctly

### (Configuration of Information Processing Apparatus 2)

The information processing apparatus 2 includes a conversion section (conversion means) 21 and a determination section (determination means) 22. The conversion section 21 sequentially applies a plurality of conversion rules to at least one of two character strings constituting a merging target character string pair to carry out conversion. The determination section 22 determines whether or not a character string pair after the conversion indicates the same object.

As described above, the information processing apparatus 2 according to the present example embodiment employs the configuration of: sequentially applying a plurality of conversion rules to at least one of two character strings constituting a merging target character string pair to carry out conversion; and determining whether or not a character string pair after the conversion indicates the same object.

According to the above configuration, it is possible to bring about an example advantage of correctly merging even dissimilarly expressed character strings. According to the configuration, it is possible to bring about also an example advantage of correctly merging even a character string pair that does not become similar character strings by a single conversion using one conversion rule.

### (Merging Program)

The functions of the information processing apparatus 2 described above can also be realized by a program. The merging program according to the present example embodiment employs the configuration of causing a computer to function as: a conversion means that sequentially applies a plurality of conversion rules to at least one of two character strings constituting a merging target character string pair to carry out conversion; and a determination means that determines whether or not a character string pair after the conversion indicates the same object. Therefore, according to the merging program of the present example embodiment, it is possible to bring about an example advantage of correctly merging even dissimilarly expressed character strings, and also correctly merging even a character string pair that does not become similar character strings by a single conversion using one conversion rule.

### (Configuration of Information Processing Apparatus 3)

The information processing apparatus 3 includes a conversion section (conversion means) 31 and a training section (training means) 32. The conversion section 31 sequentially applies a plurality of conversion rules to at least one of two character strings constituting a character string pair included in training data to carry out conversion, the training data being used to generate a determination model for determining whether or not a merging target character string pair indicates the same object. The training section 32 generates the determination model by machine learning in which character string pairs after the conversion are used as training data.

As described above, the information processing apparatus 3 according to the present example embodiment employs the configuration of: sequentially applying a plurality of conversion rules to at least one of two character strings constituting a character string pair included in training data to carry out conversion, the training data being used to generate a determination model for determining whether or not a merging target character string pair indicates the same object; and generating the determination model by machine learning in which character string pairs after the conversion are used as training data.

According to the configuration, it is possible to generate a determination model that makes it possible to merge, with high accuracy, a character string pair which has been converted. Moreover, by using this determination model, it is possible to bring about an example advantage of correctly merging even dissimilarly expressed character strings. Moreover, it is possible to correctly merge even a character string pair that does not become similar character strings by a single conversion using one conversion rule.

### (Training Program)

The functions of the information processing apparatus 3 described above can also be realized by a program. The training program according to the present example embodiment employs the configuration of causing a computer to function as: a conversion means that sequentially applies a plurality of conversion rules to at least one of two character strings constituting a character string pair included in training data to carry out conversion, the training data being used to generate a determination model for determining whether or not a merging target character string pair indicates the same object; and a training means that generates the determination model by machine learning in which character string pairs after the conversion are used as training data. Therefore, according to the training program of the present example embodiment, it is possible to generate a determination model that makes it possible to merge, with high accuracy, a character string pair which has been converted. Moreover, by using this determination model, it is possible to bring about an example advantage of correctly merging even dissimilarly expressed character strings. Moreover, it is possible to correctly merge even a character string pair that does not become similar character strings by a single conversion using one conversion rule.

### (Flows of Conversion Pattern Decision Method, Merging Method, and Training Method)

FIG. 2 is a flowchart illustrating flows of a training data generation method, a merging method, and a training method, according to the first example embodiment of the present invention. Note that S11 and S12 indicate the conversion pattern decision method, S21 and S22 indicate the merging method, and S31 and S32 indicate the training method.

### (Conversion Pattern Decision Method)

In S11, at least one processor acquires a data set including a plurality of character string pairs in each of which whether or not character strings therein indicate the same object is known.

In S12, the at least one processor decides, based on results of trials to convert each of the plurality of character string pairs included in the data set, a conversion pattern that heightens accuracy in determining whether or not the character string pair included in the data set indicates the same object. Thus, the conversion pattern decision method illustrated in FIG. 2 ends.

As described above, the conversion pattern decision method according to the present example embodiment employs the configuration of: acquiring a data set including a plurality of character string pairs in each of which whether or not character strings therein indicate the same object is known; and deciding, based on results of trials to convert each of the plurality of character string pairs included in the data set, a conversion pattern that heightens accuracy in determining whether or not the character string pair included in the data set indicates the same object. According to the above configuration, it is possible to bring about an example advantage of correctly merging even dissimilarly expressed character strings, as with the foregoing information processing apparatus 1.

An execution subject of each step in the conversion pattern decision method may be a processor that is included in the information processing apparatus 1 or may be a processor that is included in another apparatus. Alternatively, the execution subject of each step can be processors that are provided in different apparatuses. This also applies to the merging method and the training method described below.

### (Merging Method)

In S21, at least one processor sequentially applies a plurality of conversion rules to at least one of two character strings constituting a merging target character string pair to carry out conversion.

In S22, the at least one processor determines whether or not a character string pair after the conversion indicates the same object. Thus, the merging method illustrated in FIG. 2 ends.

As described above, the merging method according to the present example embodiment employs the configuration of: sequentially applying a plurality of conversion rules to at least one of two character strings constituting a merging target character string pair to carry out conversion; and determining whether or not a character string pair after the conversion indicates the same object.

According to the configuration, it is possible to bring about an example advantage of correctly merging even dissimilarly expressed character strings, and also correctly merging even a character string pair that does not become similar character strings by a single conversion using one conversion rule, as with the foregoing information processing apparatus 2.

(Training method)

In S31, at least one processor sequentially applies a plurality of conversion rules to at least one of two character strings constituting a character string pair included in training data to carry out conversion, the training data being used to generate a determination model for determining whether or not a merging target character string pair indicates the same object.

In S32, the at least one processor generates the determination model by machine learning in which character string pairs after the conversion are used as training data. Thus, the training method illustrated in FIG. 2 ends.

As described above, the training method according to the present example embodiment employs the configuration of: sequentially applying a plurality of conversion rules to at least one of two character strings constituting a character string pair included in training data to carry out conversion, the training data being used to generate a determination model for determining whether or not a merging target character string pair indicates the same object; and generating the determination model by machine learning in which character string pairs after the conversion are used as training data.

According to the configuration, it is possible to generate a determination model that makes it possible to merge, with high accuracy, a character string pair which has been converted, as with the foregoing information processing apparatus 3. By using this determination model, it is possible to bring about an example advantage of correctly merging even dissimilarly expressed character strings, and also correctly merging even a character string pair that does not become similar character strings by a single conversion using one conversion rule.

### Second Example Embodiment

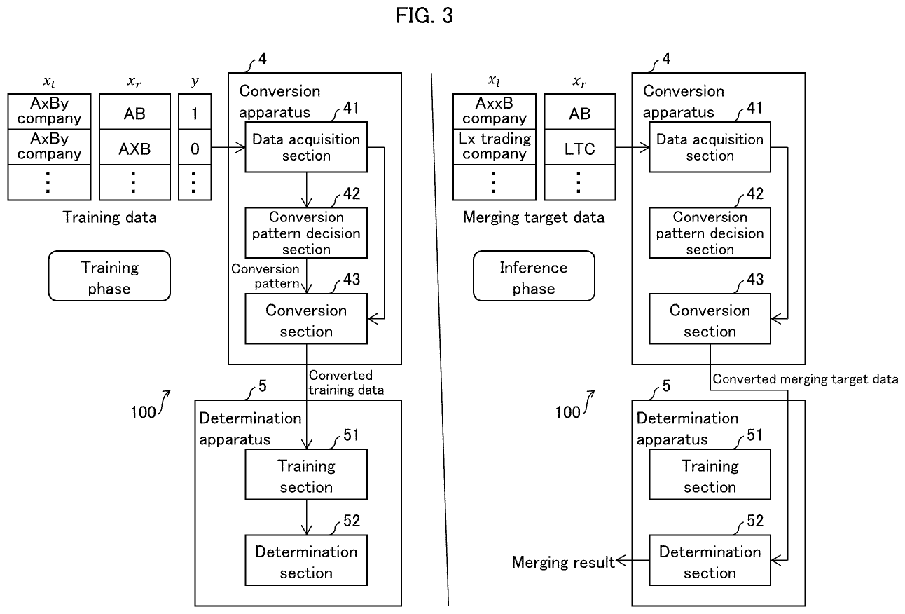

Next, the following description will discuss a second example embodiment of the present invention with reference to FIG. 3. FIG. 3 is an explanatory diagram illustrating a determination system 100 according to the present example embodiment. The determination system 100 is a system that determines whether or not a pair of merging target character strings indicates the same object, and includes a conversion apparatus (information processing apparatus) 4 and a determination apparatus 5.

The conversion apparatus 4 decides a conversion pattern of character strings and converts a character string in accordance with the decided conversion pattern. The conversion apparatus 4 includes a data acquisition section (data acquisition means) 41, a conversion pattern decision section (conversion pattern decision means) 42, and a conversion section 43. Since the functions of these constituent elements are similar to those of the data acquisition section 11, the conversion pattern decision section 12, and the conversion sections 21 and 31 illustrated in FIG. 1, descriptions thereof will not be repeated here.

The determination apparatus 5 determines whether or not a pair of merging target character strings indicates the same object. The determination apparatus 5 also includes a function of generating a determination model used for the determination. The determination apparatus 5 includes a training section 51 and a determination section 52. Since the functions of these constituent elements are similar to those of the training section 32 and the determination section 22 illustrated in FIG. 1, descriptions thereof will not be repeated here.

### (Training Phase)

In determining whether or not a pair of merging target character strings indicates the same object, the determination system 100 first generates, by machine learning using training data, a determination model for the determination. In a training phase, first, a data acquisition section 41 of the conversion apparatus 4 acquires training data. The training data acquired is a data set including a plurality of character string pairs in each of which whether or not character strings therein indicate the same object is known.

In FIG. 3, one of character strings in a character string pair is represented by x₁, the other is represented by xᵣ, and whether or not these character strings indicate the same object is represented by y. Note that y=1 means that the x₁ and the xᵣ indicate the same object, and y=0 means that the x₁ and the xᵣ do not indicate the same object. For example, in the training data illustrated in FIG. 3, a character string pair in which x₁=“AxBy Company” and xᵣ=“AB” is represented by y=1. This means that the character string “AxBy Company” and the character string “AB” indicate the same object (in this example, the same company).

Next, the conversion pattern decision section 42 decides, based on results of trials to convert each of character string pairs included in the training data, a conversion pattern that heightens accuracy in determining whether or not the character string pair included in the training data indicates the same object. Details of the conversion pattern decision method will be described later.

Next, the conversion section 43 converts each character string pair included in the training data in accordance with the conversion pattern which has been decided by the conversion pattern decision section 42. Thus, converted training data is generated. The converted training data which has been generated is output to the determination apparatus 5.

In the determination apparatus 5, the training section 51 carries out machine learning using the converted training data acquired from the conversion apparatus 4, and thus generates a determination model for determining whether or not a merging target character string pair indicates the same object. Thus, the training phase process ends.

### (Inference Phase)

In an inference phase, the data acquisition section 41 of the conversion apparatus 4 acquires merging target data. The merging target data is data including at least one character string pair which is to be determined in terms of whether or not the character string pair indicates the same object. As with the training data described above, one of character strings in a character string pair included in the merging target data can be represented by x₁ and the other can be represented by xᵣ.

Next, the conversion section 43 converts each character string pair included in the merging target data in accordance with the conversion pattern which has been decided by the conversion pattern decision section 42 in the training phase. Thus, converted merging target data is generated. The converted merging target data which has been generated is output to the determination apparatus 5.

In the determination apparatus 5, the determination section 52 determines, using the determination model generated in the training phase, whether or not a character string pair included in the converted merging target data acquired from the conversion apparatus 4 indicates the same object. The determination section 52 then outputs a determination result, that is, a merging result. Thus, the inference phase process ends.

### (Specific Application Example)

For example, the following description assumes a case in which there are two target data tables each of which includes a plurality of records, and expressions of records that indicate the same object but are expressed differently in the respective target data tables are to be unified. Each of the target data tables includes a large number of records, and therefore manual merging takes a great deal of time and labor.

In this case, the training data may be prepared by pairing character strings extracted from the respective target data tables, and associating each pair of character strings with correct answer data indicating whether or not those character strings indicate the same object. Character strings used as training data can be a part of records included in the target data tables. Therefore, the time and labor taken to generate such training data are sufficiently small as compared with a case where all merging of target data tables is carried out manually.

By using the training data as described above, the conversion pattern decision section 42 can decide a conversion pattern that is effective in merging between target data tables. Moreover, by converting, using the conversion pattern, other character string pairs extracted from the target data tables, it is possible to merge (unify expressions) with high accuracy between the target data tables.

For example, in a case where replacement or omission specific to target data tables has been made, a conversion pattern for returning character strings to ones before such replacement or omission is decided. Thus, it is possible that other records (that have not been used as training data) that are included in the target data tables and that have been replaced or omitted as described above are returned, in accordance with the decided conversion pattern, to character strings before being replaced or omitted, and then whether or not those records indicate the same object is determined. Generally, it is difficult to merge, with high accuracy, records in which specific replacements and/or omissions have been made. However, according to the determination system 100, it is possible to merge even such records with high accuracy.

### (Example of Conversion Rule for Deriving Conversion Pattern)

A conversion pattern for converting a character string can be obtained by combining a plurality of conversion rules in an application order thereof. The conversion rule is a rule for converting one character string into another. The conversion rule can be expressed by a function (mapping from a character string space to a character string space) which outputs a character string when a character string is input. For example, in a case where a certain conversion rule is set to be a function f₁, a character string obtained by converting a character string x₁ by this conversion rule is expressed as f₁(x₁). A character string obtained by further converting the transferred character string by another conversion rule (function f₂) is expressed as f₂(f₁(x₁)).

Any conversion rule can be applied as long as the conversion rule contributes to merging. Examples of the conversion rule include conversion in terms of character type (e.g., conversion into hiragana, conversion into the Roman alphabet, and the like), extraction of an initial letter, conversion of a Chinese numeral into an Arabic numeral, translation into another language, replacement of abbreviations, replacement with specific symbols, and the like. The translation can be carried out using dictionary data or the like or can be a machine translation using a machine translation algorithm. A target language into which the translation is to be carried out may be decided in advance. Moreover, for replacement of abbreviations or replacement of specific symbols, replacement may be carried out by using dictionary data or the like in accordance with a predetermined replacement rule.

Thus, the conversion pattern to be decided by the conversion pattern decision section 42 may include at least any of conversion rules which are a translation into a character string in another language, extraction of an initial letter, and conversion in terms of character type.

Each of these conversion rules is effective for converting a pair of character strings that indicate the same object but are dissimilarly expressed into a pair of similarly expressed character strings. Therefore, according to the configuration, it is possible to heighten accuracy in merging dissimilarly expressed character strings. For example, by carrying out translation into a character string in another language, it is possible to correctly merge character strings that indicate the same object but are dissimilarly expressed because of being written in different languages. The same applies to conversion in terms of character type. Moreover, in a record such as a database or a data table, character strings in each of which initial letters of a plurality of words are combined are often used. Therefore, it can be said that extraction of an initial letter is also one of effective conversion rules.

By generating a conversion pattern by combining such various conversion rules, it is possible to correctly merge even a character string pair that does not become similar character strings by a single conversion using one conversion rule. However, even with the same conversion rules, an ultimate character string can vary depending on an application order thereof. Therefore, which conversion rules are applied in which order greatly affects determination accuracy in merging.

For example, merge target character strings are assumed to be x₁=“NIKKEI (in two Chinese characters)” and xᵣ=“NKK”. Both of these terms can be used to mean the “Nikkei stock average” but are dissimilar character strings. Therefore, those terms as they are will not be determined to be character strings indicating the same object. It is supposed to apply the following conversion rules to the x₁ for conversion.
f₁: Extract an initial letter
f₂: Convert into hiragana
f₃: Convert into the Roman alphabet

Here, it is assumed that the conversion rules are applied to the x₁ in an order of f₁→f₂→f₃. In this case, f₁(x₁)=“NICHI (in one Chinese character)”, f₂(f₁(x₁))=“NICHI (in two hiragana characters)”, and f₃(f₂(f₁(x₁)))=“Nichi”. It is difficult to regard the character string “Nichi” obtained by these conversions to be similar to the xᵣ=“NKK”. Therefore, the conversion pattern f₁→f₂→f₃ cannot be regarded as effective for merging the x₁=“NIKKEI (in two Chinese characters)” and the xᵣ=“NKK”.

Meanwhile, it is assumed that the conversion rules are applied to the x₁ in an order of f₂→f₃→f₁. In this case, f₂(x₁) =“NICHI (in two hiragana characters)-KEI (in two hiragana characters)”, f₂(f₁(x₁))=“Nichi-Kei”, and f₃(f₂(f₁(x₁)))=“NK”. The character string “NK” obtained by these conversions is similar to the xᵣ=“NKK”. Therefore, the conversion pattern f₂→f₃→f₁ can be regarded as a conversion pattern that heightens determination accuracy in merging the x₁=“NIKKEI (in two Chinese characters)” and the xᵣ=“NKK”.

### (Example 1 of Conversion Pattern Decision Method)

As described above, the application order of the conversion rules affects merging accuracy. Therefore, the conversion pattern decision section 42 decides, using training data acquired by the data acquisition section 41, a conversion pattern that can heighten determination accuracy in merging.

For example, the conversion pattern decision section 42 may carry out, for each of a plurality of different conversion patterns, a trial to determine whether or not a character string pair which has been converted in accordance with that conversion pattern indicates the same object. Then, the conversion pattern decision section 42 may decide a conversion pattern based on results of evaluating determination accuracy in the respective trials.

According to the configuration, a conversion pattern is decided based on an evaluation result in which determination accuracy is evaluated for each of conversion patterns. Therefore, it is possible to decide, with high reliability, a conversion pattern that heightens accuracy in determining whether or not each of character string pairs included in the data set indicates the same object.

For example, in a case where R conversion rules are defined, R^{N} conversion patterns are obtained by selecting and arranging N conversion rules from those conversion rules. Therefore, the conversion pattern decision section 42 may convert each of the character string pairs included in the training data in accordance with each of the conversion patterns, determine whether or not each of character string pairs after the conversion indicates the same object, and evaluate accuracy of the determination.

Note that a method for determining whether or not a converted character string pair indicates the same object is not particularly limited. It is possible to carry out determination with use of a determination model generated by supervised learning, or with use of a determination model generated by unsupervised learning. Moreover, a method for evaluating determination accuracy is not particularly limited. For example, the determination may be carried out on all of or some of character string pairs included in training data, and a percentage of correct answers may be used as an evaluation value. In this case, the conversion pattern decision section 42 may decide that a conversion pattern achieving the highest percentage of correct answers is a conversion pattern that can heighten determination accuracy.

Through the above described processes, the conversion pattern decision section 42 can decide a conversion pattern that can heighten determination accuracy in merging for each character string pair included in training data. Note that, as a result of the above described processes, it may occur that a conversion pattern constituted by a single conversion rule is decided as the best conversion pattern.

This also applies to Example 2 described below.

### (Example 2 of Conversion Pattern Decision Method)

The conversion pattern decision section 42 may decide a conversion pattern by reinforcement learning in which a reward is determination accuracy in determining whether or not a converted character string pair indicates the same object. With the configuration, it is possible to decide, with high reliability, a conversion pattern that heightens accuracy in determining whether or not each of character string pairs included in the data set indicates the same object. Moreover, there is an example advantage that a calculation amount does not become enormous even in a case where the number of conversion rules to be subjected to trials is large, as compared with a case where determination accuracy is evaluated for each of conversion patterns.

A “state” in the reinforcement learning may be defined as conversion rules selected so far and an application order thereof. Moreover, an “action” in the reinforcement learning may be defined as further selecting a conversion rule and ending selection of a conversion rule. Thus, based on a result of trial to convert each of character string pairs included in the training data, a conversion pattern is decided which heightens accuracy in determining whether or not each of the character string pairs included in the training data indicates the same object.

For example, in a case where 20 conversion rules f₁ through f₂₀ are defined, a state in which conversion rules are applied in an order of f₃→f₁→f₉ is expressed as f₉(f₁(f₃(x₁))). In this state, a selectable “action” is either further selecting a conversion rule from the f₁ through f₂₀ or ending selection of a conversion rule. By ending selection of a conversion rule, a “reward” is decided. For example, in a case where selection of a conversion rule is ended in a state of f₉(f₁(f₃(x₁))), it is possible to calculate determination accuracy in a case in which conversion is carried out in accordance with the conversion pattern f₉(f₁(f₃(x₁))) and decide a reward based on the calculated determination accuracy. By repeatedly carrying out such a process, it is possible to decide, for each character string pair included in training data, a conversion pattern that can maximize accuracy in determining whether or not the character string pair indicates the same object.

A method for calculating determination accuracy is not particularly limited. For example, a part of training data is used as test data, each of character string pairs included in the test data is converted in accordance with the above described conversion pattern, and whether or not the converted character string pair indicates the same object is determined by a predetermined determination method. Then, a percentage of correct answers is calculated from a determination result for each piece of test data, and this percentage of correct answers may be used as an evaluation value for determination accuracy.

### Third Example Embodiment

### (Configuration of Information Processing Apparatus 6)

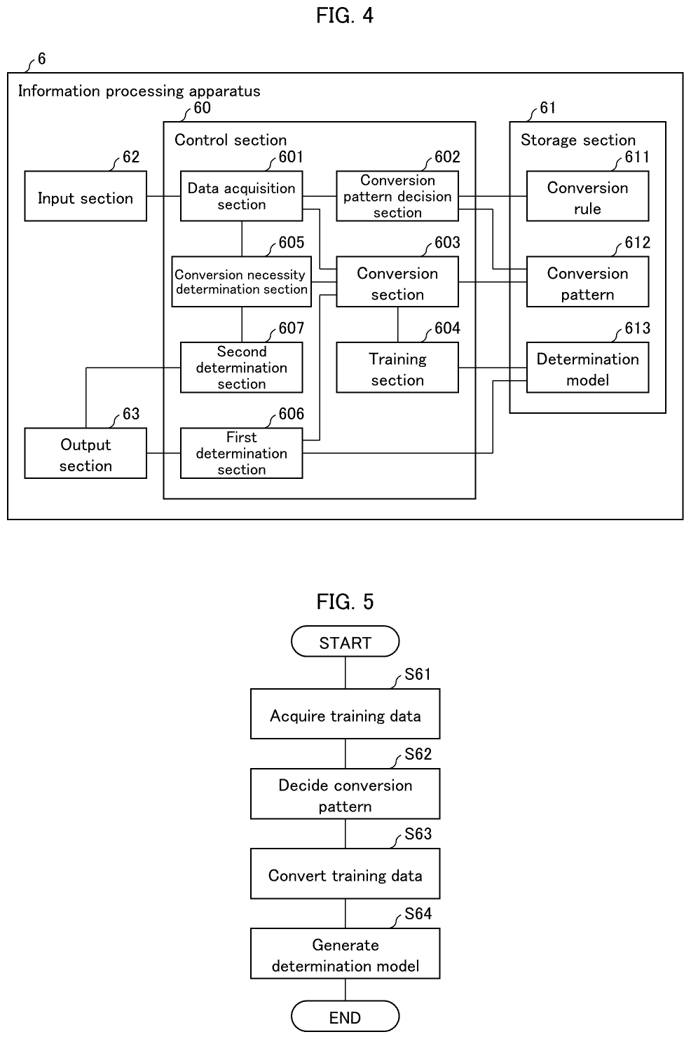

The following description will discuss a configuration of an information processing apparatus 6 according to the present example embodiment, with reference to FIG. 4. FIG. 4 is a block diagram illustrating the configuration of the information processing apparatus 6. As illustrated in FIG. 4, the information processing apparatus 6 includes a control section 60 that comprehensively controls components of the information processing apparatus 6, and a storage section 61 that stores various kinds of data used by the information processing apparatus 6. Moreover, the information processing apparatus 6 includes an input section 62 for receiving input to the information processing apparatus 6, and an output section 63 for allowing the information processing apparatus 6 to output information.

The control section 60 includes a data acquisition section (data acquisition means) 601, a conversion pattern decision section (conversion pattern decision means) 602, a conversion section (conversion means) 603, a training section (training means) 604, a conversion necessity determination section 605, a first determination section (determination means) 606, and a second determination section 607. The storage section 61 stores a conversion rule 611, a conversion pattern 612, and a determination model 613.

The data acquisition section 601 acquires data to be processed by the information processing apparatus 6. More specifically, the data acquisition section 601 acquires training data used in decision of the conversion pattern 612 and generation of the determination model 613. The training data is a data set including a plurality of character string pairs in each of which whether or not character strings therein indicate the same object is known. The data acquisition section 601 acquires merging target data, that is, a character string pair in which whether or not character strings therein indicate the same object is unknown.

The conversion pattern decision section 602 decides, based on results of trials to convert each of character string pairs included in the training data acquired by the data acquisition section 601, the conversion pattern 612 that heightens accuracy in determining whether or not each of the character string pairs included in the training data indicates the same object. Since the method for deciding the conversion pattern 612 is as described above, descriptions thereof will not be repeated here.

The conversion section 603 converts a merging target character string pair in accordance with the conversion pattern 612 which has been decided by the conversion pattern decision section 602.

The training section 604 generates, by machine learning in which character string pairs converted by the conversion section 603 are used as training data, a determination model 613 for determining whether or not the merging target character string pair indicates the same object. A machine learning algorithm is not particularly limited, as long as the machine learning algorithm can classify character string pairs into a pair indicating the same object and a pair indicating different objects.

For example, the training section 604 may generate a determination model 613 which is a logistic regression, a random forest, a support vector machine (SVM), a neural network, or the like. The determination model 613 may use character strings constituting a character string pair directly as input data. Alternatively, the determination model 613 may use, as input data, a feature quantity calculated from character strings constituting a character string pair. For example, it is possible that character strings constituting a character string pair are expressed by vectors, and a feature quantity in which those vectors are concatenated is used as input data.

The conversion necessity determination section 605 determines whether or not to cause the conversion section 603 to convert a merging target character string pair. The determination method is not particularly limited. For example, the conversion necessity determination section 605 may cause a user to select whether to convert a merging target character string pair. In this case, the conversion necessity determination section 605 may display the merging target character string pair and a character string pair used as training data on a display apparatus (that may be included in the information processing apparatus 6 or may be an apparatus external to the information processing apparatus 6). In this case, the user only needs to decide whether to carry out conversion depending on whether or not the merging target character string pair and the character string pair used as training data are similar combinations. For example, in a case where both of the merging target character string pair and the character string pair used as training data are a combination of a character string of Chinese characters (kanji) and a character string of capital letters of the Roman alphabet, it may be decided to carry out conversion, and this decision may be input into the information processing apparatus 6 via the input section 62.

Alternatively, the conversion necessity determination section 605 may determine whether or not to carry out conversion by, for example, using a determination model (i.e., a model generated by machine learning) into which a character string pair is input and from which data indicating whether or not to convert the character string pair is output. Alternatively, for example, the conversion necessity determination section 605 may decide to carry out conversion in a case where a combination of character types of the merging target character string pair is included in the character string pair used as training data, whereas decide not to carry out conversion in a case where such a combination is not included.

The first determination section 606 determines whether or not a character string pair (a merging target character string pair) which has been converted by the conversion section 603 indicates the same object. More specifically, the first determination section 606 inputs the converted character string pair into the determination model 613 and determines whether or not the character string pair indicates the same object based on an output value from the determination model 613.

The second determination section 607 determines whether or not the merging target character string pair indicates the same object. The second determination section 607 differs from the first determination section 606 in that the second determination section 607 carries out determination for a character string pair which has not been converted by the conversion section 603. The determination method by the second determination section 607 is not particularly limited. For example, the second determination section 607 may calculate a degree of similarity of character strings constituting a merging target character string pair and carry out the determination based on the calculated degree of similarity. Alternatively, for example, the second determination section 607 may carry out the determination by using a determination model generated by machine learning which is similar to that for the determination model 613, except that training data has not been converted.

The conversion rule 611 indicates content of the conversion process and is used for deriving the conversion pattern 612. The conversion pattern 612 is constituted by one or more conversion rules 611. As the conversion rule 611, for example, it is possible to apply various conversion processes listed in the above described “Example of conversion rule for deriving conversion pattern”.

The conversion pattern 612 indicates content of a conversion process that has been decided by the conversion pattern decision section 602 and that is applied to at least one of character strings in a character string pair. According to the conversion pattern decision section 602, a conversion pattern 612 can be decided in which a plurality of conversion rules 611 are combined in an application order thereof. The conversion pattern 612 may indicate, for example, a combination of conversion rules, an application order thereof, and a conversion target (i.e., which one of x₁ and xᵣ is to be converted).

The determination model 613 determines whether or not a merging target character string pair indicates the same object, and is generated by the training section 604. As described above, the determination model 613 is generated by training using converted training data. The determination model 613 uses, as input data, a merging target character string pair which has been converted.

As described above, the information processing apparatus 6 according to the present example embodiment employs the configuration of including: the conversion section 603 that converts a merging target character string pair in accordance with the conversion pattern which has been decided by the conversion pattern decision section 602; and the first determination section 606 that determines whether or not the character string pair which has been converted by the conversion section 603 indicates the same object. Therefore, according to the information processing apparatus 6 of the present example embodiment, it is possible to bring about an example advantage of correctly merging even dissimilarly expressed character strings.

Moreover, the information processing apparatus 6 according to the present example embodiment employs the configuration of including: the conversion section 603 that converts a merging target character string pair in accordance with the conversion pattern which has been decided by the conversion pattern decision section 602; and the training section 604 that generates, by machine learning using converted character string pairs as training data, a determination model 613 for determining whether or not the merging target character string pair indicates the same object. Therefore, according to the information processing apparatus 6 of the present example embodiment, it is possible to bring about, in addition to the example advantage brought about by the information processing apparatus 1 according to the first example embodiment, an example advantage of generating the determination model 613 that can merge, with high accuracy, a character string pair which has been converted.

### (Process Flow: in Training)

The following description will discuss a flow of a process carried out in training by the information processing apparatus 6 according to present example embodiment, with reference to FIG. 5. FIG. 5 is a flowchart illustrating a flow of a process carried out by the information processing apparatus 6 in training. Note that, among S61 through S64 illustrated in FIGS. 5, S61 and S62 are a conversion pattern decision method, and S63 and S64 are a training method. The processes in S61 and S62 and the processes in S63 and S64 do not necessarily need to be continuously carried out.

In S61, the data acquisition section 601 acquires training data. The training data is a data set including a plurality of character string pairs in each of which whether or not character strings therein indicate the same object is known. The training data can be acquired by any method. For example, the data acquisition section 601 may acquire training data input by the user via the input section 62. Alternatively, the data acquisition section 601 may acquire, by wired or wireless communication, training data stored in a storage apparatus or a storage medium.

In S62, the conversion pattern decision section 602 decides, based on results of trials to convert each of character string pairs included in the training data acquired in S61, a conversion pattern that heightens accuracy in determining whether or not each of the character string pairs included in the training data indicates the same object. Then, the conversion pattern decision section 602 causes the storage section 61 to store the decided conversion pattern. The conversion pattern thus stored is the conversion pattern 612 illustrated in FIG. 4.

As described above, a conversion pattern is generated by combining the conversion rules 611 stored in the storage section 61. As the conversion pattern decision method, it is possible to apply, for example, the method as described in

“Example 1 of conversion pattern decision method” or “Example 2 of conversion pattern decision method” described above.

In S63, the conversion section 603 applies the conversion pattern 612 decided in S62 to convert the training data acquired in S61. More specifically, the conversion section 603 sequentially applies, in accordance with the order indicated in the conversion pattern 612, a plurality of conversion rules indicated in the conversion pattern 612 to at least one of two character strings constituting a character string pair included in the training data acquired in S61, and thus the conversion section 603 carries out conversion. Note that, in S62, there is a possibility that a conversion pattern constituted by a single conversion rule is decided. In this case, conversion is carried out in S63 by applying the decided single conversion rule.

In S64, the training section 604 generates, by machine learning in which character string pairs converted in S63 are used as training data, a determination model for determining whether or not a merging target character string pair indicates the same object. Then, the training section 604 causes the storage section 61 to store the generated determination model. The determination model thus stored is the determination model 613 illustrated in FIG. 4. Thus, the process of FIG. 5 ends.

Note that, among the above processes, a series of processes of acquiring training data (S61) and converting the acquired training data (S63) can be referred to as a training data generation method. According to the training data generation method of the present example embodiment, it is possible to generate training data for generating a determination model that makes it possible to merge, with high accuracy, a character string pair which has been converted.

### (Process Flow: in Merging)

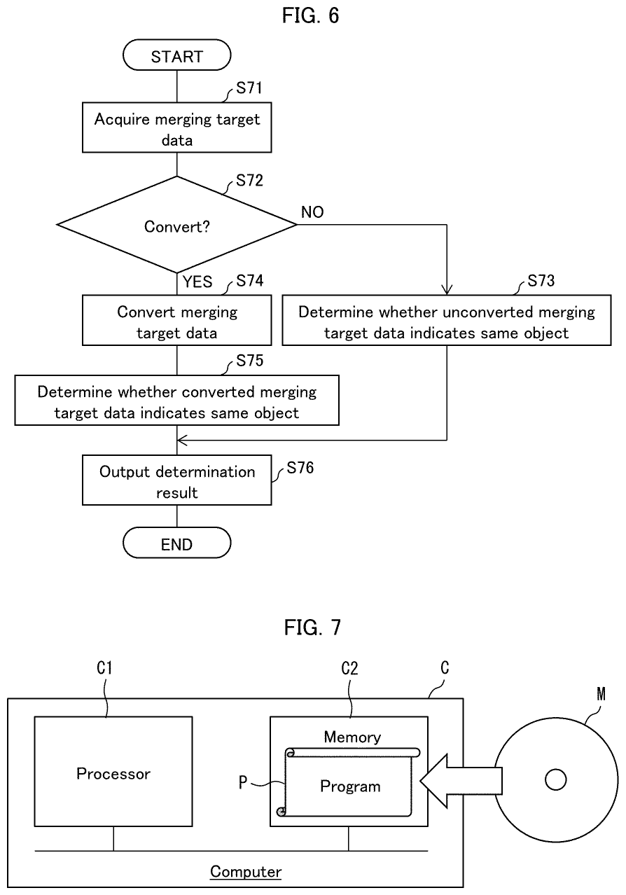

The following description will discuss a flow of a process (merging method) carried out in merging by the information processing apparatus 6 according to present example embodiment, with reference to FIG. 6. FIG. 6 is a flowchart illustrating a flow of a process carried out by the information processing apparatus 6 in merging.

In S71, the data acquisition section 601 acquires merging target data. The merging target data is a pair of character strings which are unknown as to whether or not these character strings indicate the same object. The merging target data can be acquired by any method. For example, the data acquisition section 601 may acquire merging target data input by the user via the input section 62. Alternatively, the data acquisition section 601 may acquire, by wired or wireless communication, merging target data stored in a storage apparatus or a storage medium.

In S72, the conversion necessity determination section 605 determines whether or not to convert the merging target data acquired in S71. In a case where it has been determined in S72 to carry out conversion (YES in S72), the process proceeds to S74. Meanwhile, in a case where it has been determined in S72 that conversion is not carried out (NO in S72), the process proceeds to S73.

In S73, the second determination section 607 determines whether or not the merging target data acquired in S71 indicates the same object. Here, the second determination section 607 determines whether or not a character string pair in the merging target data which has not been converted by the conversion section 603 indicates the same object. After the determination ends, the process proceeds to S76.

In S74, the conversion section 603 applies the conversion pattern 612 decided in S62 in FIG. 5 to convert the merging target data acquired in S71. More specifically, the conversion section 603 sequentially applies, in accordance with the order indicated in the conversion pattern 612, a plurality of conversion rules indicated in the conversion pattern 612 to at least one of two character strings constituting a character string pair included in the merging target data acquired in S71, and thus the conversion section 603 carries out conversion. Note that, in a case where a conversion pattern constituted by a single conversion rule is decided in S62 of FIG. 5, conversion is carried out in S74 by applying the decided single conversion rule.

In S75, the first determination section 606 determines, using the determination model 613 generated in S64 in FIG. 5, whether or not a character string pair in merging target data which has been converted by the conversion section 603 in S74 indicates the same object. After the determination ends, the process proceeds to S76.

In S76, the determination result is output. Specifically, in a case where the determination has been carried out in S73, the second determination section 607 causes the output section 63 to output the determination result of S73. Meanwhile, in a case where the determination has been carried out in S75, the first determination section 606 causes the output section 63 to output the determination result of S75. Thus, the process of FIG. 6 ends.

Note that the information processing apparatus 6 may carry out, instead of the process of S76 or together with the process of S76, a process of unifying character strings constituting merging target data which has been determined to indicate the same object. For example, it is possible to unify character strings by replacing one of the character strings constituting the merging target data with the other character string. Alternatively, for example, it is possible to unify character strings by replacing two character strings constituting the merging target data with an superordinate concept character string encompassing those two character strings. As described above, the merging method according to an example aspect of the present invention may include unifying character strings constituting merging target data which have been determined to indicate the same object. This also applies to the above described first and second example embodiments.

### (Supplementary Note Regarding Conversion Target)

In S62 of FIG. 5, the conversion pattern decision section 602 may decide a conversion pattern for one of character strings constituting a character string pair, or may decide a conversion pattern for each of character strings constituting a character string pair. For example, in a case where one of character strings in a character string pair is referred to as x₁ and the other is referred to as xᵣ, the conversion pattern decision section 602 may decide a conversion pattern only for the x₁ or may decide a conversion pattern only for the xᵣ. Alternatively, it is possible to decide both a conversion pattern for the x₁ and a conversion pattern for the xᵣ.

Therefore, in S74 of FIG. 6, the conversion section 603 can convert one of character strings constituting merging target data or can convert both of the character strings. Here, in a case where a conversion target (i.e., which one of the x₁ and the xᵣ is to be converted) is not defined in the conversion pattern 612 stored in the storage section 61, the conversion section 603 decides a character string to be converted. This process is carried out between S72 and S74 in FIG. 6.

A method for deciding a conversion target character string is not particularly limited. For example, the conversion section 603 may cause a user to select a conversion target character string. In this case, the conversion section 603 may display a merging target character string pair and the conversion pattern 612 on a display apparatus (that may be included in the information processing apparatus 6 or may be an apparatus external to the information processing apparatus 6). In this case, the user only needs to carry out selection such that the merging target character string is converted in accordance with a conversion pattern 612 that seems to be effective for the character string.

The conversion section 603 may decide a conversion target character string regardless of user selection. For example, the conversion section 603 may decide, as a conversion target of the conversion pattern 612, a character string that can be converted by a conversion rule to be applied first among conversion rules indicated by the conversion pattern 612. For example, in a case where the conversion target is a combination of a character string of Chinese characters and a character string of letters of the Roman alphabet, and the first conversion rule indicated by the conversion pattern 612 is conversion into hiragana, the conversion section 603 may set the conversion target of the conversion pattern 612 to be the character string of Chinese characters.

### Software Implementation Example

The functions of part of or all of the information processing apparatuses 1 through 3, the conversion apparatus 4, the determination apparatus 5, and the information processing apparatus 6 (hereinafter, referred to as the present apparatuses) can be realized by hardware such as an integrated circuit (IC chip) or can be alternatively realized by software.

In the latter case, each of the present apparatuses is realized by, for example, a computer that executes instructions of a program that is software realizing the foregoing functions. FIG. 7 illustrates an example of such a computer (hereinafter, referred to as “computer C”). The computer C includes at least one processor C1 and at least one memory C2. The memory C2 stores a program P for causing the computer C to function as the present apparatuses. In the computer C, the processor C1 reads the program P from the memory C2 and executes the program P, so that the functions of the present apparatuses are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### (Supplementary Note 1)

An information processing apparatus, including: a data acquisition means that acquires a data set including a plurality of character string pairs in each of which whether or not character strings therein indicate the same object is known; and a conversion pattern decision means that decides, based on results of trials to convert each of the plurality of character string pairs included in the data set, a conversion pattern that heightens accuracy in determining whether or not the character string pair included in the data set indicates the same object. According to the configuration, it is possible to correctly merge dissimilarly expressed character strings.

### (Supplementary Note 2)

The information processing apparatus according to supplementary note 1, further including: a conversion means that converts a merging target character string pair in accordance with the conversion pattern which has been decided by the conversion pattern decision means; and a determination means that determines whether or not the character string pair which has been converted by the conversion means indicates the same object. According to the configuration, it is possible to correctly merge dissimilarly expressed character strings.

### (Supplementary Note 3)

The information processing apparatus according to supplementary note 1, further including: a conversion means that converts each of the plurality of character string pairs included in the data set in accordance with the conversion pattern which has been decided by the conversion pattern decision means; and a training means that generates, by machine learning using character string pairs after the conversion as training data, a determination model for determining whether or not a merging target character string pair indicates the same object. According to the configuration, it is possible to generate a determination model that makes it possible to merge, with high accuracy, a character string pair which has been converted.

### (Supplementary Note 4)

The information processing apparatus according to any one of supplementary notes 1 through 3, in which: the conversion pattern is obtained by combining a plurality of conversion rules in an application order thereof; and the conversion pattern decision means carries out, for each of a plurality of different conversion patterns, a trial to determine whether or not a character string pair which has been converted in accordance with that conversion pattern indicates the same object, and decides a conversion pattern based on results of evaluating determination accuracy in the respective trials. According to the configuration, it is possible to decide, with high reliability, a conversion pattern that heightens accuracy in determining whether or not the character string pair included in the data set indicates the same object.

### (Supplementary Note 5)

The information processing apparatus according to any one of supplementary notes 1 through 3, in which: the conversion pattern decision means decides a conversion pattern by reinforcement learning in which a reward is determination accuracy in determining whether or not a character string pair after the conversion indicates the same object. According to the configuration, it is possible to decide, with high reliability, a conversion pattern that heightens accuracy in determining whether or not the character string pair included in the data set indicates the same object. Moreover, there is an example advantage that a calculation amount does not become enormous even in a case where the number of conversion rules to be subjected to trials is large, as compared with a case where determination accuracy is evaluated for each of conversion patterns.

### (Supplementary Note 6)

The information processing apparatus according to any one of supplementary notes 1 through 5, in which: the conversion pattern includes at least any of conversion rules which are a translation into a character string in another language, extraction of an initial letter, and conversion in terms of character type. According to the configuration, it is possible to heighten accuracy in merging dissimilarly expressed character strings.

### (Supplementary Note 7)

An information processing apparatus, including: a conversion means that sequentially applies a plurality of conversion rules to at least one of two character strings constituting a merging target character string pair to carry out conversion; and a determination means that determines whether or not a character string pair after the conversion indicates the same object. According to the configuration, it is possible to correctly merge dissimilarly expressed character strings, and also correctly merge even a character string pair that does not become similar character strings by a single conversion using one conversion rule.

### (Supplementary Note 8)

An information processing apparatus, including: a conversion means that sequentially applies a plurality of conversion rules to at least one of two character strings constituting a character string pair included in training data to carry out conversion, the training data being used to generate a determination model for determining whether or not a merging target character string pair indicates the same object; and a training means that generates the determination model by machine learning in which character string pairs after the conversion are used as training data. According to the configuration, it is possible to generate a determination model that makes it possible to merge, with high accuracy, a character string pair which has been converted. Moreover, by using this determination model, it is possible to bring about an example advantage of correctly merging even dissimilarly expressed character strings.

### (Supplementary Note 9)

A conversion pattern decision method, including: acquiring, by at least one processor, a data set including a plurality of character string pairs in each of which whether or not character strings therein indicate the same object is known; and deciding, by the at least one processor based on results of trials to convert each of the plurality of character string pairs included in the data set, a conversion pattern that heightens accuracy in determining whether or not the character string pair included in the data set indicates the same object. According to the configuration, it is possible to correctly merge dissimilarly expressed character strings.

### (Supplementary Note 10)

A merging method, including: sequentially applying, by at least one processor, a plurality of conversion rules to at least one of two character strings constituting a merging target character string pair to carry out conversion; and determining, by the at least one processor, whether or not a character string pair after the conversion indicates the same object. According to the configuration, it is possible to correctly merge dissimilarly expressed character strings, and also correctly merge even a character string pair that does not become similar character strings by a single conversion using one conversion rule.

### (Supplementary Note 11)

A training method, including: sequentially applying, by at least one processor, a plurality of conversion rules to at least one of two character strings constituting a character string pair included in training data to carry out conversion, the training data being used to generate a determination model for determining whether or not a merging target character string pair indicates the same object; and generating, by the at least one processor, the determination model by machine learning in which character string pairs after the conversion are used as training data. According to the configuration, it is possible to generate a determination model that makes it possible to merge, with high accuracy, a character string pair which has been converted. Moreover, by using this determination model, it is possible to bring about an example advantage of correctly merging even dissimilarly expressed character strings.

### (Supplementary Note 12)

A conversion pattern decision program for causing a computer to function as: a data acquisition means that acquires a data set including a plurality of character string pairs in each of which whether or not character strings therein indicate the same object is known; and a conversion pattern decision means that decides, based on results of trials to convert each of the plurality of character string pairs included in the data set, a conversion pattern that heightens accuracy in determining whether or not the character string pair included in the data set indicates the same object. According to the configuration, it is possible to correctly merge dissimilarly expressed character strings.

### (Supplementary Note 13)

A merging program for causing a computer to function as: a conversion means that sequentially applies a plurality of conversion rules to at least one of two character strings constituting a merging target character string pair to carry out conversion; and a determination means that determines whether or not a character string pair after the conversion indicates the same object. According to the configuration, it is possible to correctly merge dissimilarly expressed character strings, and also correctly merge even a character string pair that does not become similar character strings by a single conversion using one conversion rule.

### (Supplementary Note 14)

A training program for causing a computer to function as: a conversion means that sequentially applies a plurality of conversion rules to at least one of two character strings constituting a character string pair included in training data to carry out conversion, the training data being used to generate a determination model for determining whether or not a merging target character string pair indicates the same object; and a training means that generates the determination model by machine learning in which character string pairs after the conversion are used as training data. According to the configuration, it is possible to generate a determination model that makes it possible to merge, with high accuracy, a character string pair which has been converted. Moreover, by using this determination model, it is possible to bring about an example advantage of correctly merging even dissimilarly expressed character strings.

### Additional Remark 3

Furthermore, some of or all of the foregoing example embodiments can also be expressed as below.

An information processing apparatus, including at least one processor, the at least one processor carrying out: an acquisition process of acquiring a data set including a plurality of character string pairs in each of which whether or not character strings therein indicate the same object is known; and a decision process of deciding, based on results of trials to convert each of the plurality of character string pairs included in the data set, a conversion pattern that heightens accuracy in determining whether or not the character string pair included in the data set indicates the same object.

Note that the information processing apparatus can further include a memory. The memory can store a program for causing the at least one processor to carry out the acquisition process of acquiring a data set and the decision process of deciding a conversion pattern. The program can be stored in a computer-readable non-transitory tangible storage medium.

An information processing apparatus, including at least one processor, the at least one processor carrying out: a conversion process of sequentially applying a plurality of conversion rules to at least one of two character strings constituting a merging target character string pair to carry out conversion; and a determination process of determining whether or not a character string pair after the conversion indicates the same object.

Note that the information processing apparatus can further include a memory. The memory can store a program for causing the at least one processor to carry out the conversion process and the determination process. The program can be stored in a computer-readable non-transitory tangible storage medium.

An information processing apparatus, including at least one processor, the at least one processor carrying out: a conversion process of sequentially applying a plurality of conversion rules to at least one of two character strings constituting a character string pair included in training data to carry out conversion, the training data being used to generate a determination model for determining whether or not a merging target character string pair indicates the same object; and a generation process of generating the determination model by machine learning in which character string pairs after the conversion are used as training data.

Note that the information processing apparatus can further include a memory. The memory can store a program for causing the at least one processor to carry out the conversion process and the generation process. The program can be stored in a computer-readable non-transitory tangible storage medium.

### REFERENCE SIGNS LIST

1: Information processing apparatus
11: Data acquisition section (data acquisition means)
12: Conversion pattern decision section (conversion pattern decision means)
2: Information processing apparatus
21: Conversion section (conversion means)
22: Determination section (determination means)
3: Information processing apparatus
31: Conversion section (conversion means)
32: Training section (training means)
4: Conversion apparatus (information processing apparatus)
41: Data acquisition section (data acquisition means)
42: Conversion pattern decision section (conversion pattern decision means)
6: Information processing apparatus
601: Data acquisition section (data acquisition means)
602: Conversion pattern decision section (conversion pattern decision means)
603: Conversion section (conversion means)
604: Training section (training means)
606: First determination section (determination means)

What is claimed is:

1. An information processing apparatus, comprising at least one processor, the at least one processor carrying out:
a data acquisition process of acquiring a data set including a plurality of character string pairs in each of which whether or not character strings therein indicate the same object is known; and
a conversion pattern decision process of deciding, based on results of trials to convert each of the plurality of character string pairs included in the data set, a conversion pattern that heightens accuracy in determining whether or not the character string pair included in the data set indicates the same object.

2. The information processing apparatus according to claim 1, wherein:
the at least one processor carries out a conversion process of converting a merging target character string pair in accordance with the conversion pattern which has been decided in the conversion pattern decision process; and
the at least one processor carries out a determination process of determining whether or not the character string pair which has been converted in the conversion process indicates the same object.

3. The information processing apparatus according to claim 1, wherein:
the at least one processor carries out a conversion process of converting each of the plurality of character string pairs included in the data set in accordance with the conversion pattern which has been decided in the conversion pattern decision process; and
the at least one processor carries out a training process of generating, by machine learning using character string pairs after the conversion as training data, a determination model for determining whether or not a merging target character string pair indicates the same object.

4. The information processing apparatus according to claim 1, wherein:
the conversion pattern is obtained by combining a plurality of conversion rules in an application order thereof; and
in the conversion pattern decision process, the at least one processor carries out, for each of a plurality of different conversion patterns, a trial to determine whether or not a character string pair which has been converted in accordance with that conversion pattern indicates the same object, and decides a conversion pattern based on results of evaluating determination accuracy in the respective trials.

5. The information processing apparatus according to claim 1, wherein:
in the conversion pattern decision process, the at least one processor decides a conversion pattern by reinforcement learning in which a reward is determination accuracy in determining whether or not a character string pair after the conversion indicates the same object.

6. The information processing apparatus according to claim 1, wherein:
the conversion pattern includes at least any of conversion rules which are a translation into a character string in another language, extraction of an initial letter, and conversion in terms of character type.

7. An information processing apparatus, comprising at least one processor, the at least one processor carrying out:
a conversion process of sequentially applying a plurality of conversion rules to at least one of two character strings constituting a merging target character string pair to carry out conversion; and
a determination process of determining whether or not a character string pair after the conversion indicates the same object.

8. An information processing apparatus, comprising at least one processor, the at least one processor carrying out:
a conversion process of sequentially applying a plurality of conversion rules to at least one of two character strings constituting a character string pair included in training data to carry out conversion, the training data being used to generate a determination model for determining whether or not a merging target character string pair indicates the same object; and
a training process of generating the determination model by machine learning in which character string pairs after the conversion are used as training data.

9.-11. (canceled)

12. A computer-readable non-transitory storage medium storing a conversion pattern decision program for causing a computer to function as an information processing apparatus recited in claim 1, the conversion pattern decision program causing the computer to carry out the data acquisition process and the conversion pattern decision process.

13. A computer-readable non-transitory storage medium storing a merging program for causing a computer to function as an information processing apparatus recited in claim 7, the merging program causing the computer to carry out the conversion process and the determination process.

14. A computer-readable non-transitory storage medium storing a training program for causing a computer to function as an information processing apparatus recited in claim 8, the training program causing the computer to carry out the conversion process and the training process.
